(19) United States
(12) Patent Application Publication
(10) Pub. No.: US 2011/0127826 A1
(43) Pub. Date: Jun. 2, 2011

(54) HUB AND BRAKE ASSEMBLY

(75) Inventors: Timothy J. Krabill, Louisville, OH (US); James P. Flanagan, Clinton, OH (US); John D. Dougherty, Canton, OH (US)

(73) Assignee: THE TIMKEN COMPANY, Canton, OH (US)

(21) Appl. No.: 12/937,642

(22) PCT Filed: Apr. 14, 2009
(86) PCT No.: PCT/US09/40510

§ 371 Date: Dec. 9, 2010

Related U.S. Application Data
(60) Provisional application No. 61/045,101, filed on Apr. 15, 2008.
(60) Provisional application No. 61/058,460, filed on Jun. 3, 2008.

(51) Int. Cl. B60B 27/00; F16D 65/12

(52) U.S. Cl. 301/6.8

(57) ABSTRACT

A wheel hub assembly configured to receive and support a brake rotor component in either a fixed or floating arrangement, such that a wheel assembly mounted to the wheel hub abuts directly against the outboard flange of the hub, and not against an entrapped brake rotor surface.

### CROSS-REFERENCE TO RELATED APPLICATIONS

The present application is related to, and claims priority from, U.S. Provisional Patent Application Ser. No. 61/045,101 filed on Apr. 15, 2008, and is further related to, and claims priority from, U.S. Provisional Patent Application Ser. No. 61/058,460 filed on Jun. 3, 2008, both of which are herein incorporated by reference.

### STATEMENT REGARDING FEDERALLY SPONSORED RESEARCH

Not Applicable.

### BACKGROUND OF THE INVENTION

The present invention is related generally to vehicle wheel hub assemblies, and in particular, to a wheel hub and brake rotor assembly configured to receive and support a brake rotor component in either a fixed or floating arrangement, such that a wheel assembly, consisting of a tire and rim, mounted to the wheel hub abuts directly against the outboard flange of the hub, and not against an entrapped brake rotor surface.

Brake roughness is a complex issue with many influencing factors, one of which is lateral runout (LRO) of the rotor. Brake rotor LRO is the axial runout of the rotor brake surface as mounted in the vehicle with the wheel installed. This runout or waviness can create a situation in which the brake linings machine uneven thicknesses into the rotor during the off-brake condition, resulting in disc thickness variation (DTV). During the on-brake condition, DTV results in brake torque variation that can cause customer dissatisfaction. To prevent roughness from occurring after high mileage, the on-vehicle rotor runout produced from the combined effects of assembling the wheel end components together on the vehicle should be 50 microns or less.

With most existing designs (FIG. 1), the rotor is sandwiched between the wheel rim and hub flange with the hub having mounting pilots for both the rotor and the rim. Studies have shown that a number of parameters at the interface between the wheel rim, rotor and attachment studs can affect rotor runout. These parameters include variations in lug nut torque, wheel face uniformity, positional geometry of the wheel mounting holes, out-of-position studs, and the flatness of the contact surfaces. The wheel is the stiffest member in the hub/rotor/wheel sandwich and can deflect the rotor. If the wheel face is not uniform in the circumferential direction, pressure distribution between the wheel and rotor will not be uniform when the lug nuts are tightened. Similarly, depending on the wheel fastening system, the positional geometry of the wheel holes can also affect runout. This is especially true when cone nuts are used. If the center of the cone seat is misaligned with the center of the stud, the conical nut will pull the stud towards the center of the wheel hole as the nut is tightened. Finally, most existing designs have a circumferential recess on the hub flange outboard face in the area of the stud holes. This recess offsets the material that is pushed outward adjacent to the hole during the stud press-in procedure. The depth of the recess is greater than the depth of material so that the rotor does not contact the material and affect runout. A flat surface radially outward from the stud holes must be provided on the hub flange for proper seating of the rotor.

Accordingly, it would be advantageous to provide an integrated hub and brake rotor assembly which reduces the runout of the brake rotor by eliminating the interface between the wheel rim and rotor, which reduces overall weight and the size while increasing brake swept area, provides for a floating rotor design and stiffer wheel hubs, and reduces the scrub radius.

### BRIEF SUMMARY OF THE INVENTION

Briefly stated, the present disclosure provides a wheel hub assembly configured to receive and support a brake rotor component in either a fixed or floating arrangement within a plurality of recesses in the outboard flange of the hub, such that a wheel assembly mounted to the wheel hub abuts directly against the outboard flange of the hub, and not against an entrapped brake rotor surface.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a cross section illustration of a prior art wheel rim, brake rotor, and wheel hub assembly;

FIG. 2A is an inboard perspective view of a wheel hub of the present disclosure;

FIG. 2B is an outboard perspective view of the wheel hub of FIG. 2A;

FIG. 3A is a sectional view of the wheel hub and fixed brake rotor assembly of the present disclosure;

FIG. 3B is an outboard end view of the wheel hub and fixed brake rotor assembly of FIG. 3A;

FIGS. 4 illustrates the use of a protruding boss on the brake rotor adapted to engage a machined pocket on the recessed portion of the hub;

FIG. 5 illustrates the engagement of the rotor and hub components of FIG. 5;

FIG. 6 is a sectional view of the wheel hub and floating brake rotor assembly of the present disclosure;

FIG. 7A is an inboard perspective illustration of an alternate embodiment hub flange of the present disclosure incorporating a solid material ring;

FIG. 7B is an outboard perspective illustration of the hub flange of FIG. 7A;

FIG. 8 is illustrates a rotor of the present invention having inner diameter slots or recesses through which the hub passes for mounting of the rotor on the inboard side;

FIG. 9 is a partial perspective view of the brake rotor of FIG. 8, illustrating mounting holes and inner diameter slots or recesses through which the hub tabs pass;

FIG. 10 shows a cross-section of a wheel stud mounted to a hub of FIG. 8, having an inboard extension upon which the brake rotor is mounted in a floating configuration;

FIG. 11 is a sectional view of a rotor mounted to a hub outer-diameter shoulder; and

FIG. 12 is a sectional view of a rotor mounted to a hub and secured with radial attachment means.

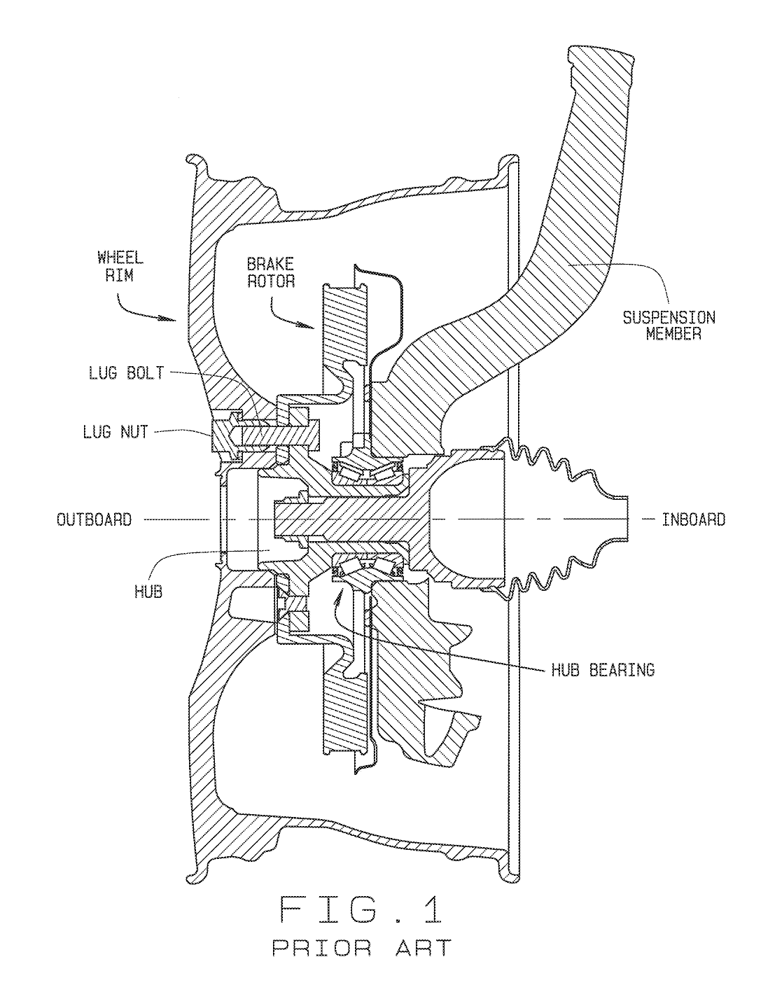

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

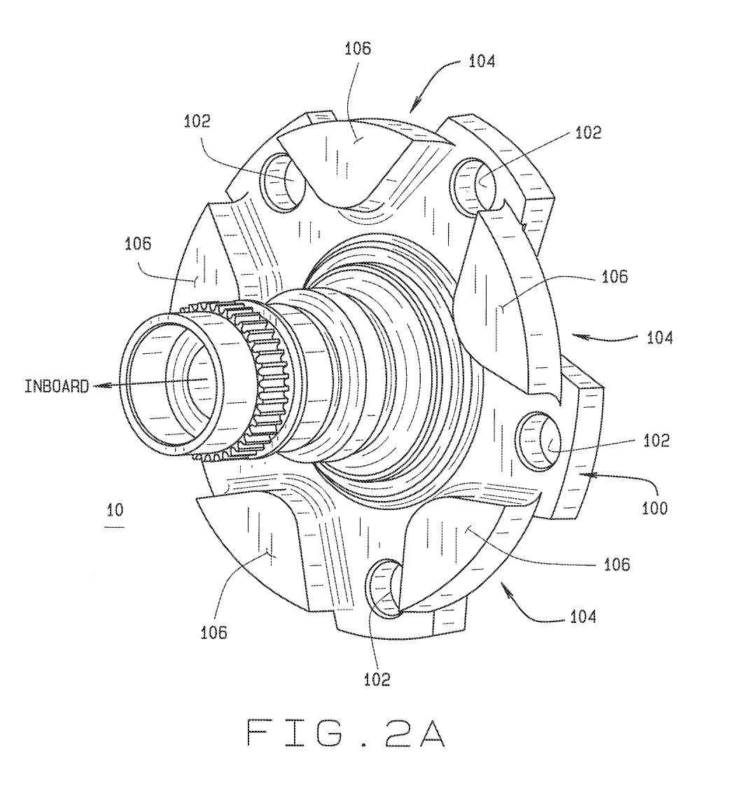

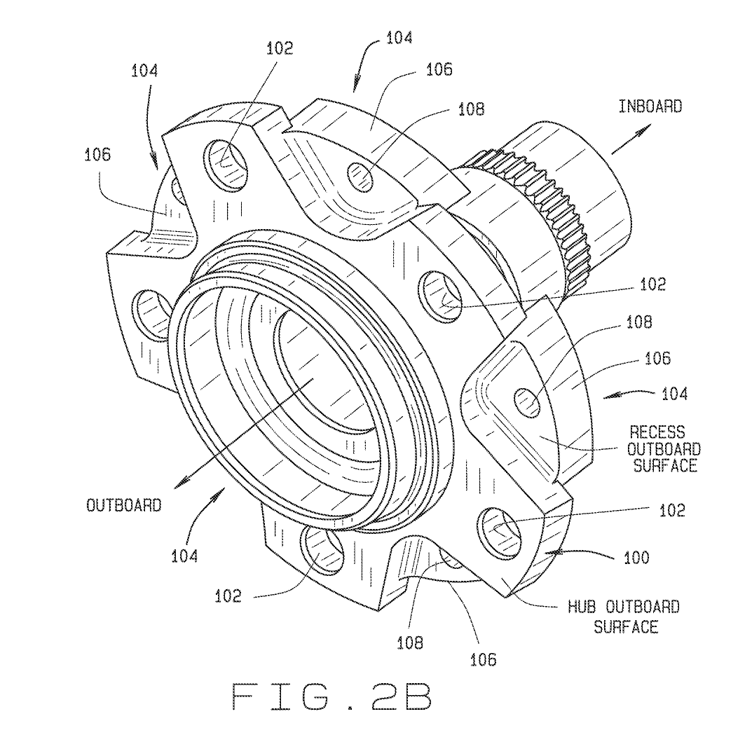

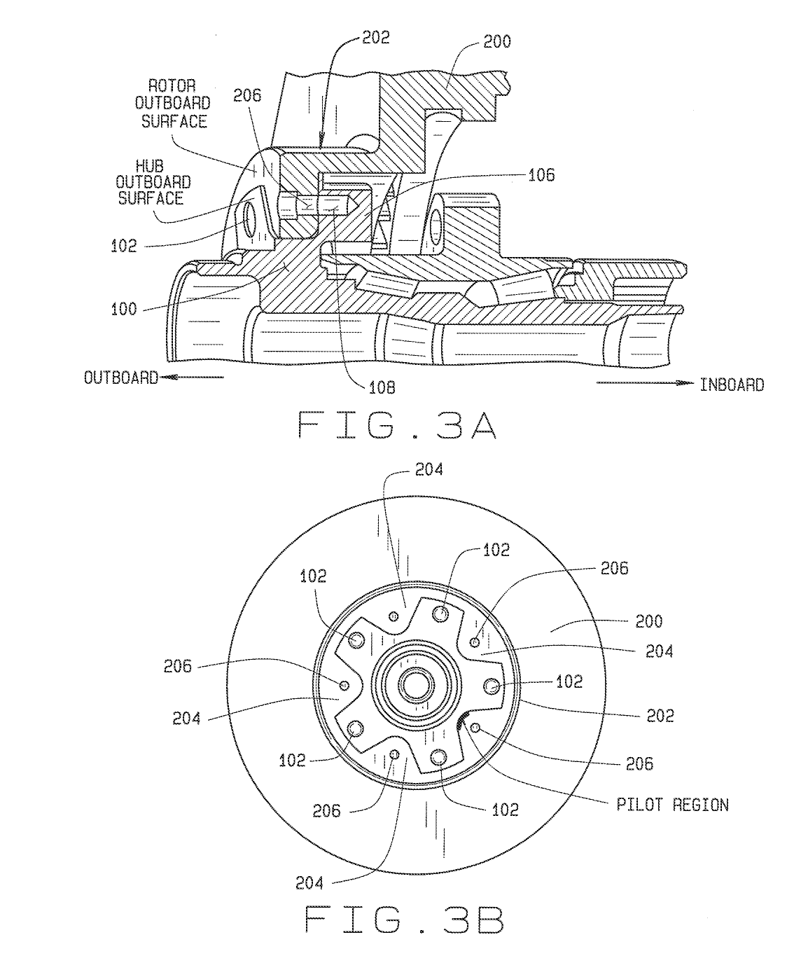

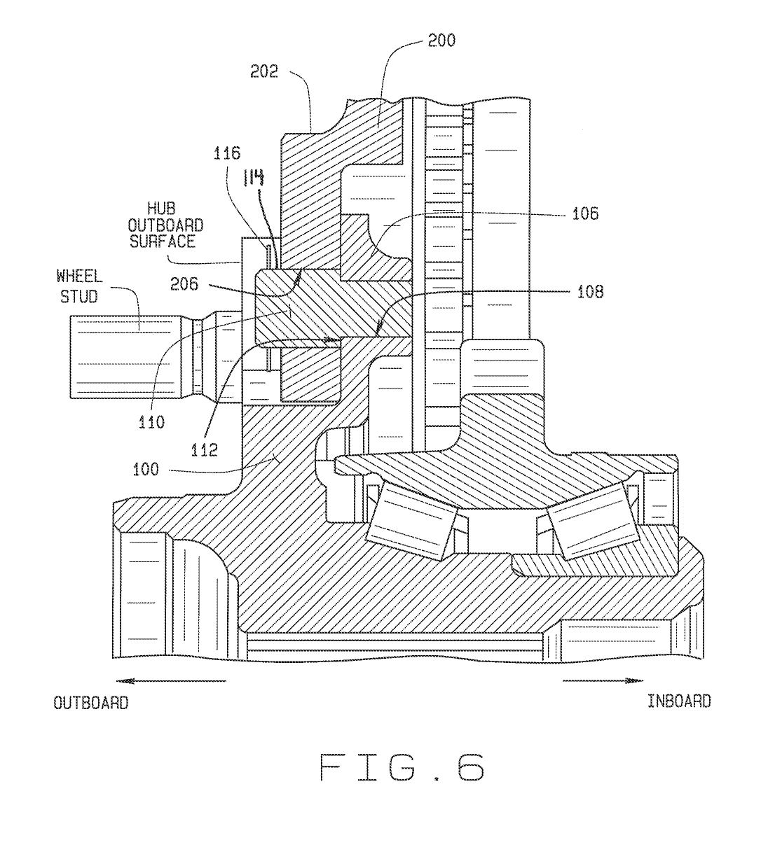

Turning to FIGS. 2A and 2B, a first embodiment of a hub 10 having a hub flange 100 of the present disclosure is shown in perspective view. The hub flange 100 has holes or bores 102 for accepting wheel studs (not shown), with recesses 104 formed into the hub flange 100 adjacent to the stud holes 102. These recesses 104 correspond axially with reinforcing material 106 which is added to the inboard side of the hub flange 100. Holes 108 in the reinforcing material 106 at the center of each recessed area 104 receive threaded bolts or pins (not shown) which are used for attachment and mounting of the brake rotor adjacent to the outboard surface of each recessed area 104. As best seen in FIGS. 3A and 3B, the brake rotor 200 includes a cylindrical center section 202 or “hat” having an inner diameter of an outboard axial end which is correspondingly scalloped, as at 204, to engage the scalloped recesses 102 in the hub flange 100. The brake rotor 200 can be either a fixed design as shown in FIGS. 3A and 3B, or a floating design as shown in FIG. 6. Stiffness of the hub flange 100 can be increased for applications where stiffness is critical.

With the fixed design shown in FIGS. 3A and 3B, threaded bolts are inserted inwardly through bores 206 in the scalloped portions 204 of the rotor hat 202 and into the threaded holes 108 in the hub recesses 104. The bolts (not shown) are tightened into counterbores against the rotor hat 202 outboard face such that the rotor 200 is seated against the outboard face of the recessed portions 104, inboard of the outboard surface of the hub flange 100. With the outboard surface of the rotor hat 202 disposed axially inboard of the outboard surface of the hub flange 100, the rotor 200 is spaced apart from a wheel rim subsequently mounted to the hub flange 100 by the wheel studs, reducing runout of the brake rotor 200 by eliminating the interface between the wheel rim and brake rotor 200.

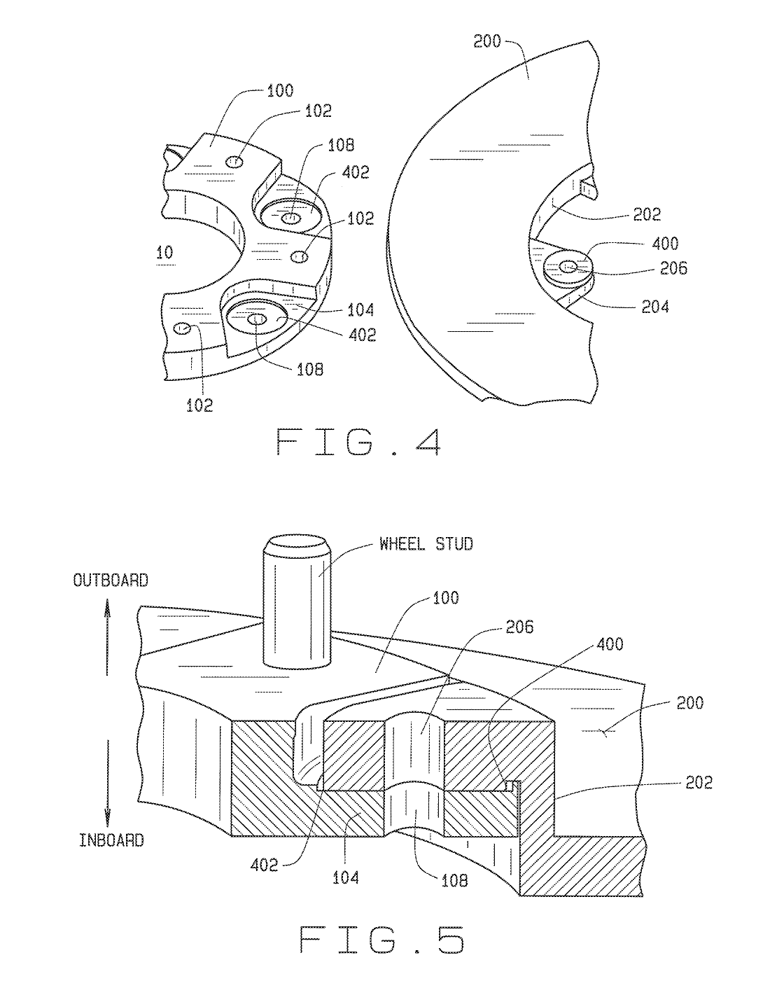

Optionally, as shown in FIGS. 4 and 5, bosses 400 may be provided on the inboard surface (mounting side) of the rotor hat scallops 204. The surfaces of each boss may be machined as part of the manufacturing process for the brake rotor 200, or are formed by a spot face operation, and become part of the mounting surface that will engage the recesses 104 of the wheel hub flange 100. Correspondingly, the wheel hub flange 100 incorporates pockets 402 in the outboard surfaces of the recessed portions 104, which engage with the bosses 400 of the rotor 200. It will be readily recognized by those of ordinary skill in the art that the reverse configuration of bosses 400 and pockets 402 may be utilized to achieve the same benefit of providing a positive engagement between the rotor 200 and the hub flange 100, without departing from the scope of the present invention.

Prior art configurations for wheel hubs and brake rotors commonly pilot the brake rotor 200 on the hub flange 100 for a full 360 degrees around the inner diameter of the rotor hat 202. With the configuration of the present disclosure shown in FIGS. 3A, 3B, the innermost diameter surfaces of the rotor scallops 204 each pilot on a radially inward surface of the hub recesses 104 as shown in FIG. 3B. The piloting surface of the present embodiments covers less surface area than the piloting surface for prior art designs. The smaller area of the pilot surfaces renders corrosion effects less of an issue during rotor removal, as compared to prior art configurations wherein the brake rotor could effectively bond or rust onto the wheel hub flange at the pilot surfaces. In addition, sufficient clearance is maintained between the adjacent sidewall surfaces of the rotor scallops 204 and the hub recesses 104 such that corrosion on these surfaces does not interfere with removal of the brake rotor 200 during service.

For the floating mounting configuration of the rotor 200, shown in FIG. 6, shoulder bolts or pins 110 can be used to mount the rotor 200 to the hub flange 100, and to allow for limited axial movement of the rotor 200 within the confines of the recessed portion 104. Once the rotor scallops 204 are seated within the hub flange recesses 104, the shoulder bolts or pins 110 are passed through the rotor mounting holes 206 and threaded or pressed into the hub holes 108 until the bolt or pin shoulder 112 is seated against the recessed surface 104 of the hub flange 100. The axial length of the shoulder section 114 of the shoulder bolt or pin 110 exceeds the thickness of the rotor scallop 204, allowing the rotor 200 to float axially along the shoulder section 114 of the bolt or pin 110, retained between the recessed surface 104 of the hub flange 100 and a cap or clip 116 adjacent the outboard end of the shoulder bolt or pin 110.

For both the fixed and floating rotor mounting configurations shown in FIGS. 3A, 3B, and 6, the overall axial length of the bolt or pin 110 and the thickness of the rotor hat 202 at the mounting holes are selected such that the bolts or pins 110 and the rotor hat portion 202 adjacent the mounting holes 206 are recessed inboard from the outboard surface of the hub flange 100 when seated within the hub recessed portions 104. A wheel assembly mounted to the hub assembly 10 therefore directly abuts against the hub flange outboard face, and the brake rotor 200 is not sandwiched or entrapped between the hub flange 100 outboard face and the wheel assembly, reducing rotor runout due to the wheel mounting.

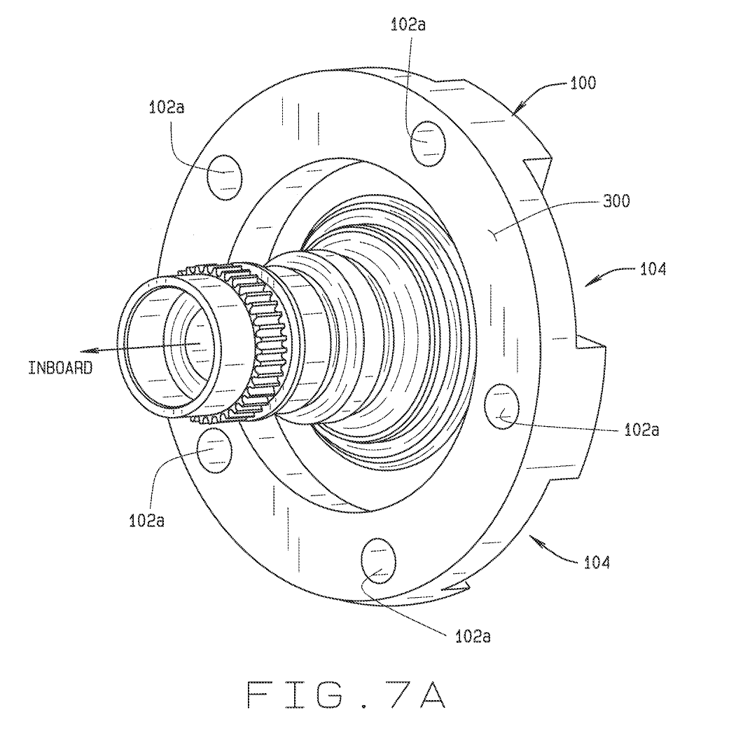

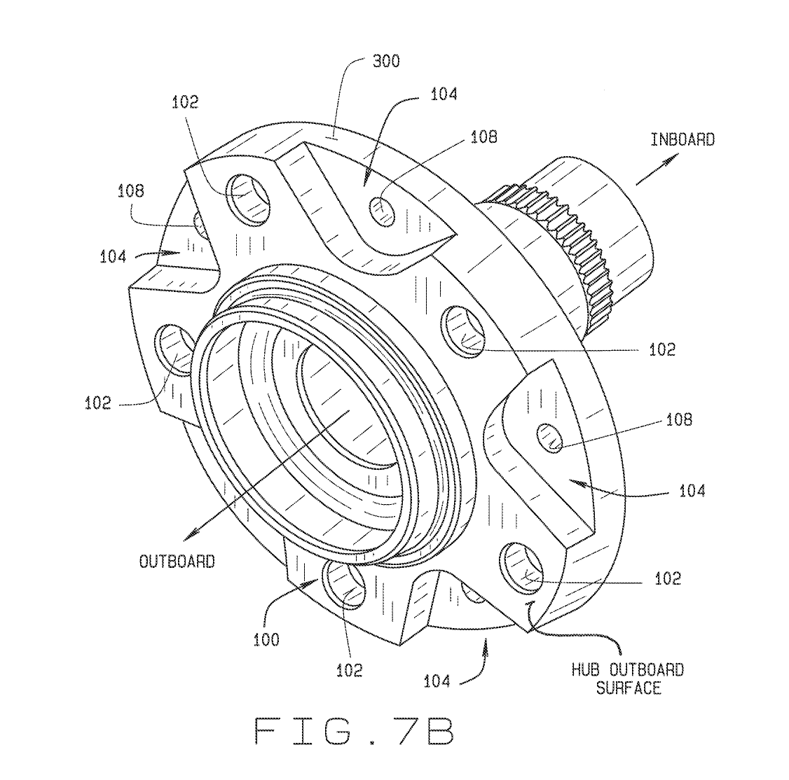

In an alternate embodiment of the present disclosure, shown in FIGS. 7A and 7B, a solid ring or annular member 300 of reinforcing material is added to the inboard surface of the hub flange 100, function in substantially the same manner as the reinforcing material 106 shown in FIGS. 2, 3, and 5. The annular member 300 can be either integral with the hub flange 100 for increased hub stiffness, or a separate component secured to the hub flange 100. An advantage of providing a separate ring or annular member 300 is that it makes it easier to control flatness of the surfaces to which the rotor 200 will be mounted, as the annular member 300 outboard surface defines the outboard surface of the hub flange recesses 104. With a separate ring or annular member 300, stud and rotor attachment holes or bores 102a, 108a are pre-drilled and the faces of the ring or annular member 300 are machined prior to assembly with the hub flange 100. As previously described, the hub flange 100 includes a plurality of recesses 104 for acceptance of the rotor hat 202. The ring or annular member 300 is assembled against the inboard face of the hub flange 100, with stud holes in the ring or annular member 300 aligned with the stud holes 102 in the hub flange 100. Wheel studs (not shown) are inserted through the stud holes 102a in the annular member 300 and the hub flange holes 102. The rotor 200 is configured with scallop 204 similar to previous embodiments discussed above, and engages the hub flange 110 in the hub recesses 104, in either a fixed or floating configuration, as previously described.

With each of the above configurations, weight savings may be realized by a reduction in the outer diameter of the hub flange 100, a reduction in the section width of the rotor hat portion 202, an elimination of the rotor mounting pilot about the circumference of the hub flange 100, and a reduction in material usage due to the scalloped design of the rotor hat 202, thereby increasing vehicle fuel efficiency and improved handling. The outer diameter of the hub flange 10 can be reduced because the rotor 200 is no longer seated against the outboard hub face and therefore a flat surface extending radially outward from the stud holes 102 is not required on the hub flange 100 to support the rotor 200. The section width of the rotor hat 202 can be reduced because the mounting surface for the rotor 200 is moved inboard from the outboard surface of the hub flange 100, to the surface of the hub flange recesses 104. Because the rotor 200 is positioned inboard of the hub flange outboard face, and is piloted either on the supporting bolts or pins, or on the hub recess sidewall surface, the rotor mounting pilot normally located on the outboard end of the hub flange 100 is no longer required, and is eliminated. Wheel stud axial length can also be reduced. Finally, the scalloped design of the rotor hat 202 and mating hub flange recesses 104 reduces the material requirement from both components.

A further benefit of the present embodiment is an increase in the swept area of the brake rotor 200 due to the reduction in diameter of the hub flange 100 which results in a smaller rotor hat inner diameter, and improved braking performance (reduced stopping distance).

Similarly, by displacing the mounting surfaces of the rotor 200 axially inward from the outboard surface of the hub flange 100, enabling the wheel rim to be mounted directly in engagement with the outboard surface of the hub flange 100, vehicle handling may be improved due to a decrease in the wheel scrub radius.

For each embodiment of the present disclosure, a brake torque applied to the brake rotor 200 by a vehicle braking system is generally transmitted indirectly to the wheel rim through the bolts or pins used to mount the rotor 200 to the hub flange 100. Other indirect means for transmitting the brake torque from the rotor 200 to the wheel rim may include an interaction between the sidewall surfaces of the rotor scallops 204 and the sidewall surfaces of the hub recesses 104, or the use of engaging splines within the recesses 104. When contact faces are utilized, sufficient clearance between the rotor 200 and associated rotor mounting bolts or pins is required to permit contact between the hub recess 104 sidewall surfaces and the rotor scallop 204 surfaces. Similarly, if splines on the inner diameter of the rotor scallops 204 are mated with splines on sidewall surfaces of the hub flange recesses 104, a means for positioning the rotor 200 such as a separable ring on the inboard face of the hub flange may be required.

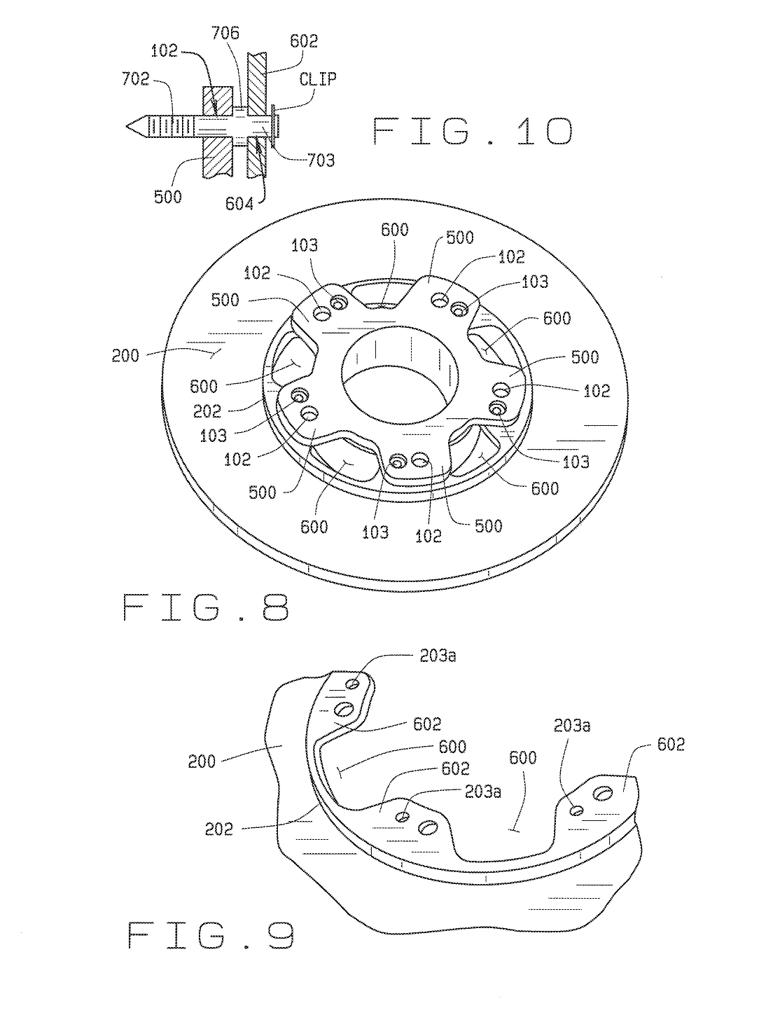

Turning to FIG. 8 through FIG. 10, an alternate embodiment is shown in which the hub 10 is provided with a plurality of radially outward projecting rotor mounting flanges 500, which are configured to pass through corresponding gaps 600 in the outboard end of the brake rotor 200 when in an aligned rotational position with the brake rotor 200. Alignment of the gaps 600 and the mounting flanges 500 permits the brake rotor 200 to be installed and removed from the hub 10 without requiring removal of the hub 10 from the vehicle. With the rotor gaps 600 aligned with the mounting flanges 500, the rotor may be installed on the hub by being moved axially inward past the mounting flanges 500, and then rotated to misalign the rotor gaps 600 and the mounting flanges 500. Misaligning the rotor gaps 600 moves the outboard surfaces 602 of the rotor hat 202 into alignment with the inboard side of the mounting flanges 500 on the hub, as best seen in FIG. 8.

As seen in FIGS. 8 and 9, each mounting flange 500 on the hub preferably includes two adjacent bores, a first bore 102 for receiving a wheel stud or bolt to secure a wheel rim against the hub outboard surface, and a second bore 103 having an outboard counterbore, for receiving a rotor attachment bolt or pin to secure the brake rotor 200 against the inboard surface of the hub mounting flanges 500 by engaging the outboard surface 602 of the brake rotor 200 in an aligned receiving bore 203a. With the embodiment shown in FIG. 8, all of the locating surfaces, such as the inboard and outboard surfaces of the mounting flanges 500 on hub 10, and the outboard surfaces of the rotor hat 202, can be turned in a lathe, thereby minimizing the manufacturing costs.

Alternatively, as shown in FIG. 10, a modified wheel bolt or stud 700 may be used to secure both the brake rotor 200 and a wheel rim to the wheel hub 10, eliminating the need for a second bore 103 in the hub mounting flanges 500. The modified wheel bolt or stud 700 includes a first portion 702 for receiving a wheel rim and lug bolt (not shown) adjacent the outboard face of the hub 10, and a second portion 703 which passes through the hub flange stud bore 102 and extends beyond the inboard surface of the hub mounting flange 500 to pass through a bore 604 in the rotor outboard surface 602. A suitable attachment means, such as a C-clip is provided adjacent the inboard end of the second portion 703, retaining the brake rotor on the modified bolt or stud 700. A suitable shoulder or spacer portion 706 may be disposed between the first portion 702 and second portion 703 to provide a desired axial spacing between the inboard surface of the mounting flanges 500 and the outboard surface 602 of the brake rotor 200.

Each of the preceding embodiments of the present disclosure has provided a wheel hub and brake rotor mounting configuration wherein the brake rotor is mounted inboard of the outboard face of the wheel hub, such that a wheel rim may be secured to the wheel hub in abutting engagement with the hub outboard face without entrapping a brake rotor surface there between. In a first set of embodiments, illustrated in FIGS. 2A-7B, the brake rotor is secured to the wheel hub within recessed portions of the hub flange 100, below the level of the hub outboard surface. In a second set of embodiments, illustrated in FIGS. 8-10, the brake rotor is secured in a removable configuration adjacent to the inboard surfaces of mounting flanges on the wheel hub 10, opposite from the attachment of the wheel rim. Each of these configurations reduces or eliminates the problems associated with mounting the rotor between the wheel rim and the wheel hub.

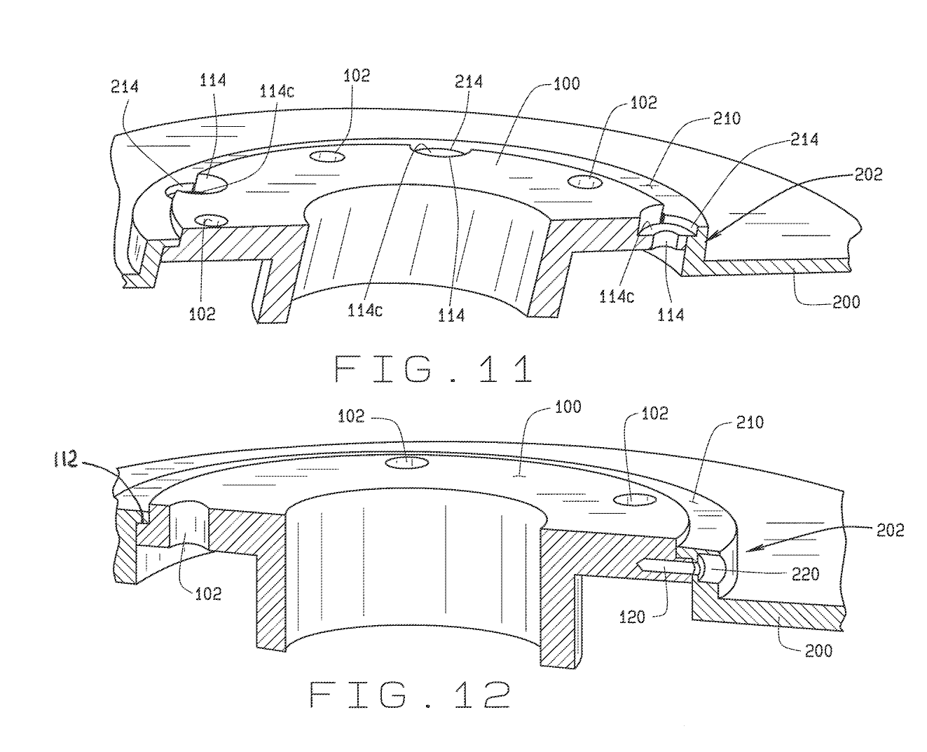

In an third set of embodiments of the present disclosure, shown in FIGS. 11 and 12, the brake rotor is mounted about the circumference of the hub flange 100, below the level of the hub flange outboard face. In a first variation, shown in FIG. 11, the outer circumference of the hub flange 100 includes an annular shoulder 112 adjacent to the outboard face. The hat portion 202 of the brake rotor 200 has a shortened axial length, and includes an annular lip 210 projecting radially inward at the outboard end of the hat portion 202. The annular lip 210 is configured to seat on the annular shoulder 112 of the hub flange, inward from the outboard surface of the hub. The rotor 200 is retained on the hub 10 by the use of clamping screws or other hardware (not shown) that clamps the rotor annular lip 210 against the annular shoulder 112 of the hub flange 100, but which remains inboard of the outboard face of the hub 10 so as to avoid engagement with a mounted wheel rim. For example, as seen in FIG. 11, a plurality of threaded retaining bores 114 may be disposed in the hub flange 100, adjacent to the annular shoulder 112. Each threaded retaining bore 114 is includes a counterbore 114c which intersects the annular shoulder 112, and is aligned with a corresponding resection 214 in the rotor annular lip 210. A cap screw or bolt (not shown) is threaded into the retaining bore 114, such that an enlarged diameter cap or head portion overlaps both the counterbore 114c and the resection 214 in the brake rotor annular lip 210, thereby entrapping the annular lip 210 against the annular shoulder 112. Braking torque exerted on the brake rotor 200 is transferred indirectly to the wheel rim through the cap screw, bolt, or other clamping hardware. A tapered counter bore or other features may optionally be added ensure rigid mounting of the rotor to resist the braking torque.

An alternate means for attaching the rotor 200 to the outer circumference of the hub flange 100 is illustrated in FIG. 12. Radially aligned and counterbored bores 220 in the rotor hat portion 202 align with radial threaded bores 120 in the outer circumference of the hub flange 100 when the rotor annular lip 210 seats on the annular shoulder 112 of the hub flange, inward from the outboard surface of the hub. Retaining bolts or pins may then be utilized to secure the brake rotor 200 to the hub flange 100.

Those of ordinary skill in the art will recognize that corrosion prevention associated with each of the above designs at the hub flange and brake rotor interface surfaces may be provided by various conventional means including coatings, anti-seizing compounds, shields, gaskets and o-rings.

As various changes could be made in the above constructions without departing from the scope of the disclosure, it is intended that all matter contained in the above description or shown in the accompanying drawings shall be interpreted as illustrative and not in a limiting sense.

1. A wheel hub assembly including a hub having a flange with an inboard face and an outboard face, a brake member supported by the hub, and a bearing assembly for coupling the wheel hub assembly to a vehicle, comprising:
a plurality of recesses disposed about the circumference of the hub flange outboard face, each of said recesses opening in a radially outward direction and in an axially outward direction from said hub flange outboard face;
a plurality of scallops projecting radially inward from an outboard end of the brake rotor member, said plurality of scallops adapted for interlocking engagement with said plurality of recesses from an axially outboard direction;
wherein said hub flange outboard face of the wheel hub assembly is adapted to receive a wheel rim in direct abutting contact; and
wherein said outboard end of said brake member is disposed axially inboard of said hub flange outboard face, and wherein said outboard end of said brake member is spaced axially apart from said wheel rim received on said hub flange outboard face.

2. The wheel hub assembly of claim 1 wherein the hub further includes a machined pocket within an outboard-facing surface of each of said recesses; and
wherein the brake member further includes a boss protruding from an inboard-facing surface of each of said plurality of scallops, each of said bosses configured to seat within an associated machined pocket.

3. The wheel hub assembly of claim 1 wherein said brake member is secured to said wheel hub assembly via a coupling member disposed in each of said plurality of recesses; and wherein each of said coupling members is disposed axially inboard of said outboard face of the wheel hub assembly.

4. The wheel hub assembly of claim 3 wherein said brake member is secured to said wheel hub assembly in a fixed configuration by a plurality of recessed retaining bolts passing through bores in said scallops and threaded into receiving bores disposed in a web of reinforcing material located axially inboard of said hub flange outboard face within each of said plurality of recesses.

5. The wheel hub assembly of claim 3 wherein said brake member is secured in a floating configuration by a plurality of threaded shoulder bolts passing through smooth bores in said scallops and threaded into receiving bores disposed in the web of reinforcing material in each of said plurality of recesses, each of said plurality of threaded shoulder bolts having a unthreaded shoulder portion with an axial length exceeding an axial thickness of said associated scallop, whereby said brake member has a limited range of axial movement along said unthreaded shoulder portions within said wheel hub recesses.

6. The wheel hub assembly of claim 5 wherein said limited range of axial movement of said brake member along said unthreaded shoulder portions of said threaded shoulder bolts is restrained in an outboard direction by end caps on each of said threaded shoulder bolts, and in an inboard direction by an outboard-facing surface of said recesses.

7. The wheel hub assembly of claim 5 wherein said limited range of axial movement of said brake member along said unthreaded shoulder portions of said threaded shoulder bolts is restrained in an outboard direction by clips secured to each of said threaded shoulder bolts, and in an inboard direction by an outboard-facing surface of said recesses.

8. The wheel hub assembly of claim 3 wherein said brake member is secured in a floating configuration by a plurality of pins passing through bores in said scallops and secured in receiving bores disposed in each of said plurality of hub recesses, each of said plurality of pins having an exposed shaft portion with an axial length exceeding an axial thickness of said associated scallop, whereby said brake member has a range of axial movement in an outboard direction within said recesses limited by a retaining means on each pin and the outboard-facing recessed surface of said wheel hub assembly.

9. The wheel hub assembly of claim 1 further including an annular member coupled to an inboard face of said wheel hub assembly, said annular member including a plurality of wheel rim stud holes, each of which is aligned with corresponding wheel rim stud holes in the wheel hub assembly.

10. The wheel hub assembly of claim 9 wherein said annular member is integrally formed with said wheel hub assembly.

11. The wheel hub assembly of claim 1 wherein each of said scallops includes at least one contact face configured for torque transfer engagement with a side surface of an associated recess in the wheel hub assembly.

12. The wheel hub assembly of claim 1 wherein each of said scallops include a plurality of splines configured for torque transfer engagement with interlocking splines of an associated recess in the wheel hub assembly.

13. (canceled)

14. (canceled)

15. (canceled)

16. (canceled)

17. (canceled)

18. (canceled)

19. (canceled)

20. A wheel hub assembly including wheel hub having an outboard face for axially supporting a wheel rim, a brake member supported by a flange on the wheel hub, and a bearing assembly for coupling the wheel hub assembly to a vehicle, comprising:
a mounting structure on said wheel hub adapted to support said brake member against axial movement and to indirectly transfer braking torque from said brake member to said wheel rim, said mounting structure supporting said brake member adjacent to, and axially inboard from, said wheel hub outboard face in a position which is axially spaced from said wheel rim; and
a retaining means configured to couple said brake member to said mounting structure.

21. A wheel hub assembly including hub having an inboard face and an outboard face, a brake member supported by the hub, and a bearing assembly for coupling the wheel hub assembly to a vehicle, comprising:
a plurality of recesses disposed about the circumference of the hub outboard face, each of said recesses opening in a radially outward direction and in an axially outward direction;
a plurality of scallops projecting radially inward from an outboard end of of the brake member, said plurality of scallops adapted for interlocking engagement with said plurality of recesses in an axially inward direction, a radially inner portion of each of said plurality of scallops configured to pilot on a radially inward surface of an associated recess; and
wherein said outboard end of said brake member is spaced adjacent to, and axially inboard, of said outboard face of the wheel hub assembly when in engagement with said plurality of recesses.

22. The wheel hub assembly of claim 21 where radially projecting sidewall surfaces of said plurality of scallops are spaced from radially projecting sidewall surfaces of said associated recesses, whereby corrosion bonding between scallops and said recess is reduced.
